(19) United States
(12) Patent Application Publication
(10) Pub. No.: US 2017/0162959 A1
(43) Pub. Date: Jun. 8, 2017

(54) Connection module for motor vehicle

(71) Applicant: Valeo Vision, Bobigny Cedex (FR)

(72) Inventor: Olivier Badia, Villiers Sur Marne (FR)

(21) Appl. No.: 15/368,779

(22) Filed: Dec. 5, 2016

(30) Foreign Application Priority Data
Dec. 7, 2015 (FR) 1561905

(51) Int. Cl. H01R 12/70

(52) U.S. Cl. CPC H01R 12/7023

(57) ABSTRACT

A connection module for a motor vehicle adapted to connect a printed circuit card to a power supply network The connection module comprises a card edge connector in which the printed circuit card can be inserted and a holding element adapted to be in an unlocked position or in a locked position and adapted to hold the printed circuit card permanently in the card edge connector when it is in a locked position.

### CROSS-REFERENCE TO RELATED APPLICATIONS

This application claims priority to the French application 1561905 filed Dec. 7, 2015, which application is incorporated herein by reference and made a part hereof.

### BACKGROUND OF THE INVENTION

1. Field of the Invention

The present invention concerns a connection module for a motor vehicle adapted to connect a printed circuit card to a power supply network.

It finds a particular, but not limiting application in lighting devices, such as the headlights of a motor vehicle.

2. Description of the Related Art

A connection module for a motor vehicle adapted to connect a printed circuit card to a power supply network is a connector of card edge type. This card edge type connector comprises, as is known to the skilled person, one jaw outfitted with contacts adapted to make contact with electrical contacts of the printed circuit card so that the latter is connected to a power supply harness.

Such a connection module is used in a lighting system like a motor vehicle headlight, the headlight comprising a housing which can receive the connection module. The mounting of this connector is usually done manually by a worker.

One inconvenience of this prior art is that the connection module is liable to become disconnected from the printed circuit card on account of a poor installation, or during the process of use if it experiences impacts or jolts. Accordingly, to solve this problem, one solution consists in outfitting the housing of the headlight with a mating part which plays the part of a retaining wall against which the connection module thrusts. This mating part is located at the bottom of the housing of the headlight.

One inconvenience of this solution is that it imposes a design constraint in the area of the headlight housing and an integration constraint in the area of the positioning of the connection module in the housing.

In this context, the present invention proposes to solve the aforementioned inconvenience.

### SUMMARY OF THE INVENTION

Toward this end, the invention proposes a connection module for a motor vehicle adapted to connect a printed circuit card to a power supply network, characterized in that it comprises:

a card edge connector in which the printed circuit card can be inserted;

a holding element adapted to be in an unlocked position or in a locked position and adapted to hold the printed circuit card permanently in the card edge connector when it is in a locked position.

Thus, as will be seen in detail below, thanks to the holding element it is no longer necessary to have a supplemental part in the housing of the lighting device to serve as a mating part, and the connection module can be positioned in different places in the housing of the lighting device.

According to nonlimiting embodiments, the connection module can furthermore comprise one or more supplemental characteristics among the following:

According to one nonlimiting embodiment, the power supply network is a power supply network of the motor vehicle or an intermediate network connected to the power supply network of the motor vehicle.

According to one nonlimiting embodiment, the card edge connector comprises a slot in which the printed circuit card can be inserted, the slot being provided with connection contacts adapted to cooperate electrically with connection tracks/contacts of the printed circuit card.

According to one nonlimiting embodiment, the holding element is adapted to slide along a transverse axis of the card edge connector to move from the unlocked position to the locked position.

The holding element is known as a slide.

According to one nonlimiting embodiment,

the card edge connector comprises at least one holding device adapted to cooperate with a holding element of the printed circuit card when the printed circuit card is inserted in the card edge connector; and

the holding element is designed to lock the holding device in its cooperation with the holding element and to release the holding device from its cooperation with the holding element.

According to one nonlimiting embodiment, the holding element of the printed circuit card is a holding orifice in which the card edge connector can be inserted.

According to one nonlimiting embodiment, the holding element is designed to:

enable the movement of the holding device into a raised position when the holding element is in the unlocked position; and

lock the holding device in a lowered position when the holding element is in the locked position.

According to one nonlimiting embodiment, when it is in a locked position, the holding element is furthermore adapted to prevent the holding device from raising up.

According to one nonlimiting embodiment, the holding device is a snap-in means or any other type of elastically deformable element.

According to one nonlimiting embodiment, the card edge connector comprises at least one holding device disposed on an upper face and/or at least one holding device disposed on a lower face.

According to one nonlimiting embodiment, the card edge connector comprises a plurality of holding devices disposed on an upper face and/or a plurality of holding devices disposed on a lower face.

According to one nonlimiting embodiment, the recess has a concave surface.

According to one nonlimiting embodiment, when it is in a lowered position, the holding device is furthermore adapted to prevent the holding element from sliding.

According to one nonlimiting embodiment, the holding element comprises furthermore a locking device of the holding element in the locked position.

According to one nonlimiting embodiment, the locking device is adapted to cooperate with a locking element provided on the card edge connector.

According to one nonlimiting embodiment, the locking element is a projecting part of the card edge connector. In one nonlimiting example, it is an unhooking element.

According to one nonlimiting embodiment, the locking device is a snap-in means adapted to be in a raised position when the holding element is in the locked position.

According to one nonlimiting embodiment,

the card edge connector further comprises a first poka-yoke to indicate the locked position of the holding element; and

the holding element further comprises a second poka-yoke adapted to cooperate with the first poka-yoke.

According to one nonlimiting embodiment, the card edge connector further comprises a plurality of orifices adapted to receive a power supply harness in order to become connected to the power supply network.

According to one nonlimiting embodiment, the card edge connector is composed of:

a first part adapted to receive a power supply harness in order to become connected to the power supply network;

a second part:
comprising a slot in which the printed circuit card can be inserted;
adapted to be inserted in the holding element; and
along which the holding element can slide.

According to one nonlimiting embodiment, the printed circuit card comprises a power supply driving circuit of an electronic component, the card edge connector being adapted to transmit an electrical power supply from the power supply network to the driving circuit. According to one nonlimiting embodiment, the electronic component is a light source.

There is also proposed a lighting device for a motor vehicle comprising a housing in which is disposed at least one connection module according to any one of the preceding characteristics, the connection module being adapted to cooperate with a printed circuit card.

According to one nonlimiting embodiment, the lighting device is a headlight.

These and other objects and advantages of the invention will be apparent from the following description, the accompanying drawings and the appended claims.

### BRIEF DESCRIPTION OF THE ACCOMPANYING DRAWINGS

The invention and its various applications will be better understood upon perusal of the following description and an examination of the accompanying figures.

FIG. 1 represents a perspective view of the connection module according to one nonlimiting embodiment of the invention, the connection module comprising a holding element and a card edge connector;

FIG. 2 represents a top view of a printed circuit card which is adapted to cooperate with the connection module of FIG. 1;

FIG. 3 represents a perspective view of the card edge connector of the connection module of FIG. 1 according to one nonlimiting embodiment;

FIG. 4 represents a top view of the card edge connector of FIG. 3;

FIG. 5 represents a front view of the card edge connector of FIGS. 3 and 4;

FIG. 6 represents a profile view of the card edge connector of FIGS. 3 to 5;

FIG. 7 represents a perspective view of the holding element of the connection module of FIG. 1 according to one nonlimiting embodiment;

FIG. 8 represents a front view of the holding element of FIG. 7;

FIG. 9 represents a perspective view of the connection module of FIG. 1, when the holding element is cooperating with the card edge connector, the holding element being in an unlocked position;

FIG. 10 represents a front view of the connection module of FIG. 9;

FIG. 11 is a zoom of a portion of the connection module of FIGS. 9 and 10;

FIG. 12 is a zoom of another portion of the connection module of FIGS. 9 and 10;

FIG. 13 represents a perspective view of the connection module of FIG. 1, when the holding element is cooperating with the card edge connector, the holding element being in a locked position;

FIG. 14 represents a front view of the connection module of FIG. 13;

FIG. 15 is a zoom of a portion of the connection module of FIGS. 13 and 14;

FIG. 16 is a zoom of another portion of the connection module of FIGS. 13 and 14;

FIG. 17 represents the printed circuit card of FIG. 2 which is cooperating with the connection module of FIGS. 3 to 12, the printed circuit card being in the process of being inserted in the card edge connector;

FIG. 18 represents the printed circuit card of FIG. 2 which is cooperating with the connection module of FIGS. 3 to 12, the printed circuit card being completely inserted in the card edge connector;

FIG. 19 represents the printed circuit card of FIG. 2 which is cooperating with the connection module of FIGS. 1, 13 to 16;

FIG. 20 is a zoom of a portion of FIG. 19; and

FIG. 21 represents the printed circuit card of FIG. 2 which is cooperating with the connection module of FIGS. 1, 13 to 16, the printed circuit card being held permanently in the card edge connector.

### DETAILED DESCRIPTION OF THE PREFERRED EMBODIMENTS

The identical elements, in structure or in function, appearing in different figures shall retain the same references, unless otherwise indicated.

The connection module 1 for a motor vehicle adapted to connect a printed circuit card 2 to a power supply network according to the invention is described in regard to FIGS. 1 to 16.

In one nonlimiting embodiment, the power supply network is a power supply network of the motor vehicle or an intermediate power supply network connected to the power supply network of the motor vehicle. In one nonlimiting example, an intermediate network is an internal power supply network of the lighting device in which the connection module 1 and the printed circuit card 2 are integrated.

In the following description, the power supply network of the motor vehicle is used as a nonlimiting example.

By motor vehicle is meant any type of motorized vehicle.

As illustrated in FIG. 1, the connection module 1 comprises:

a card edge connector 10 in which the printed circuit card 2 can be inserted;

a holding element 11 adapted to be in an unlocked position p0 or in a locked position p1 and adapted to hold the printed circuit card 2 permanently in the card edge connector 10 when it is in a locked position p1.

In the following description, the card edge connector 10 is also called a connector.

The printed circuit card 2 as well as the various elements of the connection module 1 are described in detail below.

Printed Circuit Card

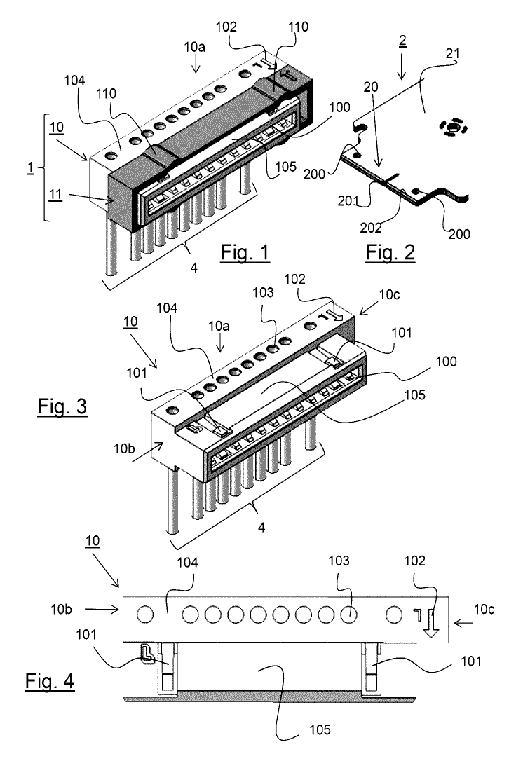

FIG. 2 illustrates the printed circuit card 2 (or PCB, Printed Circuit Board) which cooperates with the connection module 1.

In the following description, the printed circuit card 2 is also called a PCB.

The printed circuit card 2 comprises a driving circuit (not illustrated) to power at least one electronic component (not illustrated).

The driving circuit comprises in particular switches such as transistors. In nonlimiting examples, these transistors are MOSFET or IGBT. The driving of the electrical power supply of an electronic component being easily implemented by the skilled person, it is not described here.

It will be noted that the printed circuit card 2 can comprise electronic components such as ceramic capacitors in order to handle power supply peaks.

In one nonlimiting embodiment, the electronic component whose electrical power supply is driven by the driving circuit is a light source.

In one nonlimiting embodiment, the light sources are semiconductor transmitting chips.

In one nonlimiting variant, a semiconductor transmitting chip is part of a light-emitting diode.

By light-emitting diode is meant any type of light-emitting diode, whether LEDs, OLEDs (organic LEDs), AMOLEDs (active-matrix-organic LEDs), or FOLEDs (flexible OLEDs).

As is illustrated in FIG. 2, the printed circuit card 2 is adapted to cooperate with the card edge connector 10 and more particularly to be inserted in a slot in the card edge connector 10.

The card edge connector 10 is connected to a power supply harness 4. The power supply harness 4 makes it possible to route the power supply voltage coming from an electrical power supply such as a battery of the motor vehicle V and thus power the driving circuit of the printed circuit card 2.

For this purpose, the printed circuit card 2 comprises:

a body 21 on which are arranged the driving circuit and the other electronic components;

a connection edge 20 adapted to cooperate with the card edge connector 10, the connection edge 20 extending as a projection from the body 21;

a plurality of electrical contacts (not shown) adapted to make contact with the card edge connector 10 in order to establish a connection. The electrical contacts are disposed on the connection edge 20;

at least one holding element 200 adapted to cooperate with a holding device 101 of the card edge connector 10 when the printed circuit card 2 is inserted in the card edge connector 10. The holding element 200 is disposed on the connection edge 20.

In one nonlimiting embodiment, the printed circuit card 2 comprises four holding elements 200.

In one nonlimiting embodiment, the holding element 200 is a holding orifice in which holding devices 101 (described further below) of the card edge connector 10 can be inserted.

In one nonlimiting embodiment, the printed circuit card 2 further comprises a poka-yoke system 201 arranged on the connection edge 20. This system is a poka-yoke which makes it possible to avoid positioning the printed circuit card 2 backwards or in the wrong card edge connector 10.

In one nonlimiting embodiment, the printed circuit card 2 further comprises a chamfer 202 at the connection edge 20 which facilitates the inserting of the PCB 2 in the card edge connector 10.

Connection Module

The elements making up the connection module 1, namely, the card edge connector 10 and the holding element 11, are described in detail below.

Card Edge Connector

The card edge connector 10 is illustrated in FIGS. 3 to 6.

FIG. 3 illustrates a perspective view of the card edge connector 10 of the connection module 1 and FIG. 4 illustrates a top view of the card edge connector 10.

The card edge connector 10 is composed of:

a first part 104 adapted to receive a power supply harness 4 in order to become connected to a power supply network of the motor vehicle;

a second part 105, also known as the jaw:
comprising a slot 100 in which the printed circuit card 2 can be inserted;
adapted to be inserted in the holding element 11; and
along which the holding element 11 can slide.

The jaw 105 is adapted to cooperate with the connection edge 20 of the printed circuit card 2. In fact, it comprises the electrical contacts adapted to make contact with the electrical contacts situated on the connection edge 20 of the printed circuit card 2.

The card edge connector 10 comprises a plurality of orifices 103 adapted to receive the power supply harness 4 in order to become connected to the power supply network of the motor vehicle. In the nonlimiting example illustrated, the plurality of orifices 103 are formed in the first part 104.

In one nonlimiting embodiment, the card edge connector 10 comprises a poka-yoke 102, called the first poka-yoke, in order to indicate the locked position p1 of the holding element 11, and to cooperate with a poka-yoke 112, called the second poka-yoke, of the holding element 11. In one nonlimiting example, the first poka-yoke 102 is an arrow which is positioned opposite a second arrow corresponding to the second poka-yoke 112 when the holding element 11 is in the locked position p1. This makes it possible to verify that the holding element 11 is indeed locked. In the nonlimiting example illustrated, the first poka-yoke 102 is realized on the first part 104.

In one nonlimiting embodiment, the card edge connector 10 further comprises at least one holding device 101 adapted to cooperate with a holding element 200 of the printed circuit card 2 when the printed circuit card 2 is inserted in the card edge connector 10 in order to position the printed circuit card 2 in a predetermined position, namely, a position in which the connection between the contacts of the PCB 2 and the connector 10 is established.

In one nonlimiting embodiment, the holding device 101 is an elastically deformable element. In one nonlimiting variant, the holding device 101 is a snap-in means, as is illustrated in FIGS. 3 and 4.

When it is in the raised position, the holding device 101 allows the PCB 2 to be removed from the slot of the card edge connector 10.

When it is in a lowered position, the holding device 101 is adapted to hold the PCB 2 in position after being inserted in the slot of the card edge connector 10. Furthermore, the holding device 101 is adapted, when it is in a lowered position, to prevent the holding element 11 from sliding when the latter is in the locked position p1.

It will be noted that when the holding element 200 of the PCB 2 is a holding orifice, the holding device 101 inserts into the holding orifice 200.

The card edge connector 10 comprises an upper face 10a, a lower face 10b and two lateral faces 10c and 10d.

For simplicity, the same references for the faces 10a-10d will be used for the first part 104 and the jaw 105 of the card edge connector 10.

In one nonlimiting embodiment, at least one holding device 101 is disposed on an upper face 10a and/or at least one holding device 101 is disposed on a lower face 10b of the jaw 105 of the card edge connector 10. In the nonlimiting example illustrated, the card edge connector 10 comprises four holding devices 101, two on each of the faces 10a, 10b.

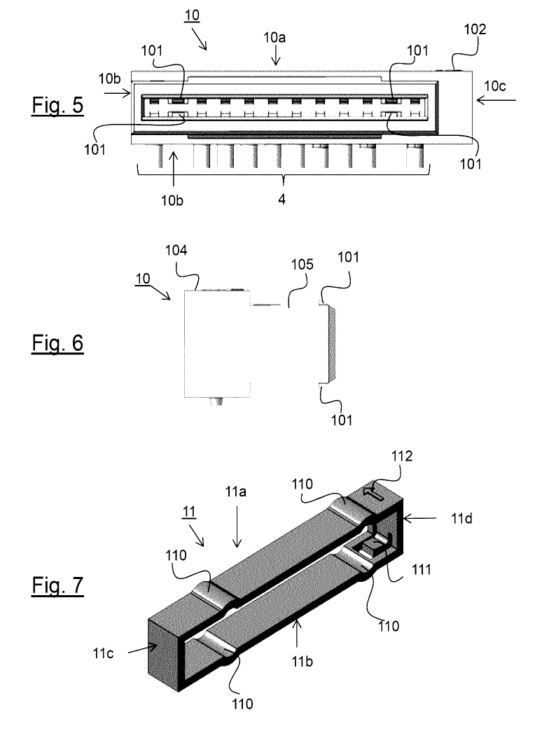

In the nonlimiting example illustrated in FIG. 5, the jaw 105 of the card edge connector 10 comprises a pair of holding devices 101 on its upper face 10a and another pair on its lower face 10b.

FIG. 6 is a sectional view of the card edge connector 10 in which one can observe two holding devices 101, one on the upper face 10a and the other on the lower face 10b of the jaw 105.

As will be seen below, the assembly of card edge connector 10 and holding element 11 makes it possible to hold the PCB 2 permanently in the card edge connector 10. By holding permanently is meant that the PCB 3 is held in a position such that the connection between its contacts and those of the card edge connector 10 is assured, and that the PCB 2 cannot be removed from the card edge connector 10. The assembly of card edge connector 10 and holding element 11 thus prevents the removal of the PCB 2 from the card edge connector 10.

Holding Element

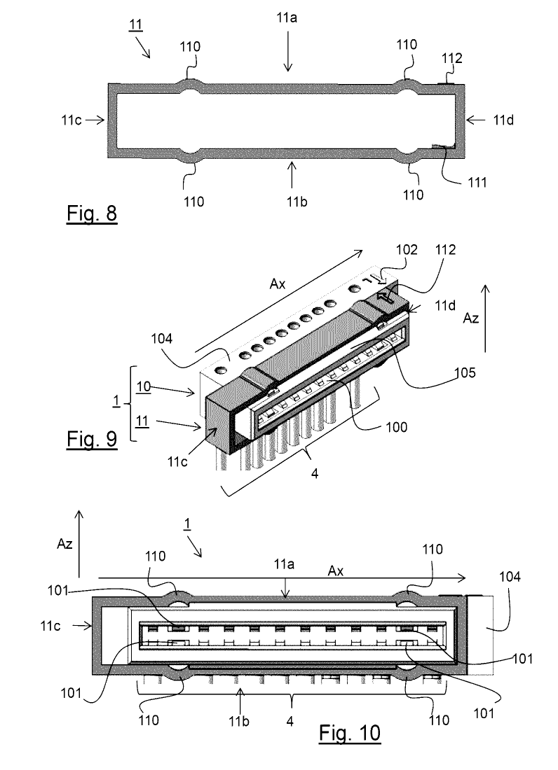

The holding element 11 is illustrated in FIGS. 7 and 8.

The cooperation of the holding element 11 with the card edge connector 10 is illustrated in FIGS. 9 to 16.

The holding element 11 is adapted to be positioned around the jaw 105 of the card edge connector 10 and to take up two positions, one unlocked p0 and the other locked p1. The holding element 11 is of greater length than the jaw 105 and of width substantially equal to that of the jaw 105. The jaw 105 is thus easily inserted into the holding element 11.

The holding element 11 comprises an upper face 11a, a lower face 11b and two lateral faces 11c and 11d. The two upper 11a and lower 11b faces are parallel to each other and substantially planar. The two lateral faces 11c and 11d are parallel to each other and substantially planar.

When the holding element 11 is positioned around the jaw 105 of the card edge connector 10, the inside (also called the inner side) of its upper face 11a is in contact with the upper face 10a of the jaw 105 and the inside (also called the inner side) of its lower face 11b is in contact with the lower face of the jaw 105.

The holding element 11 comprises:

at least one recess 110 adapted to cooperate with a holding device 101 of the card edge connector 10 when the holding element 11 is in an unlocked position p0. Thus, at least one recess 110 is provided on at least one of its upper 11a or lower 11b faces, the rest of the faces being planar;

at least one locking device 111;

at least one poka-yoke 112, called the second poka-yoke, provided on the upper face 11a.

In one nonlimiting embodiment, the recess 110 is a concave surface.

In one nonlimiting embodiment, the holding element 11 comprises a plurality of recesses 110, in particular, one recess 110 associated with each holding device 101 of the card edge connector 10. Thus, in the nonlimiting example illustrated, the holding element 11 comprises a pair of recesses 110 on the upper face 11a and a pair of recesses 110 on the lower face 11b, in particular, on the outside (also called the outer side) of the upper 11a and lower 11b faces.

In one nonlimiting embodiment, the locking device 111 is a snap-in means.

In one nonlimiting embodiment, the second poka-yoke 112 is an arrow.

The various elements of the holding element 11 are described below when the holding element 11 is in the unlocked p0 and locked p1 position.

### Unlocked Position

As is illustrated in FIG. 9 or in FIG. 10, in the unlocked position p0 the recess 110 is adapted to receive the holding device 101 of the card edge connector 10.

FIG. 11, which is a zoom view, illustrates the cooperation between the recess 110 and the holding device 101 in the unlocked position p0.

In the unlocked position p0, the holding element 11 thus enables the movement of the holding device 101 into a raised position. The latter can move along a vertical axis Az as illustrated in FIGS. 9, 10 and 11. It can thus be in a raised position or in a lowered position.

The locking device 111 is disposed on the lower face 11b of the holding element 11, inner side. It will be remembered that the inner side of the face is the side which is in contact with the lower face 10b of the jaw 105.

In the unlocked position p0, the locking device 111 cooperates with the lower face 10b of the jaw 105.

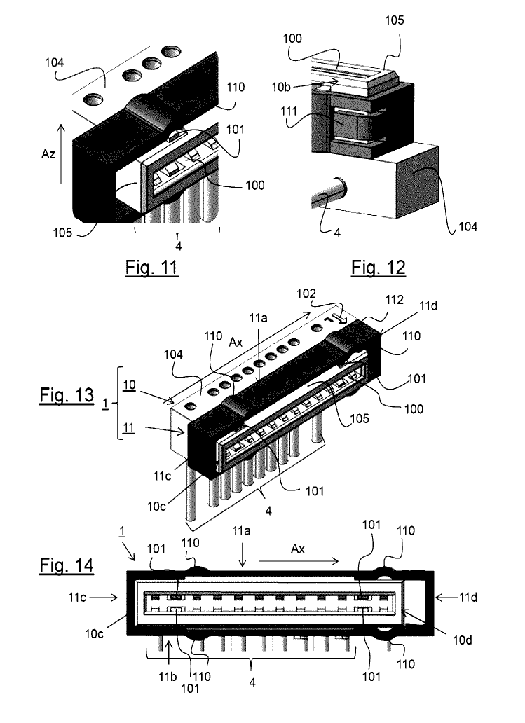

FIG. 12, which is a bottom zoom view, illustrates the cooperation between the locking device 111 and the lower face 10b of the jaw 105 in the unlocked position p0. The locking device 111 is pressed against the jaw 105. It is in a lowered position.

The second poka-yoke 112 is adapted to cooperate with the first poka-yoke 102 of the card edge connector 10.

In the nonlimiting example illustrated in FIG. 7 or FIG. 8, the second poka-yoke 112 is situated on the upper face 11a, outer side, of the holding element 11. It will be remembered that the outer side is the side which is not in contact with the upper face 10a of the jaw 105 of the card edge connector 10.

As is illustrated in FIG. 9, in the unlocked position p0, the second poka-yoke 112 is offset in relation to the first poka-yoke 102.

### Locked Position p1

move from the unlocked position p0 to the locked position p1, in one nonlimiting embodiment, the holding element 11 is adapted to slide along a transverse axis Ax (illustrated in FIGS. 9 and 10) of the card edge connector 10. This axis Ax is an axis perpendicular to the direction of insertion of the PCB 2 in the card edge connector 10.

As is illustrated in FIG. 13 or in FIG. 14, in the locked position p1 the recess 110 no longer cooperates with the holding device 101 of the card edge connector 10. The latter is no longer inserted in the recess 110.

The holding device 101 now cooperates with the planar surface, inner side, of the upper face 11a of the holding element 11. The holding device 101 is in a lowered position.

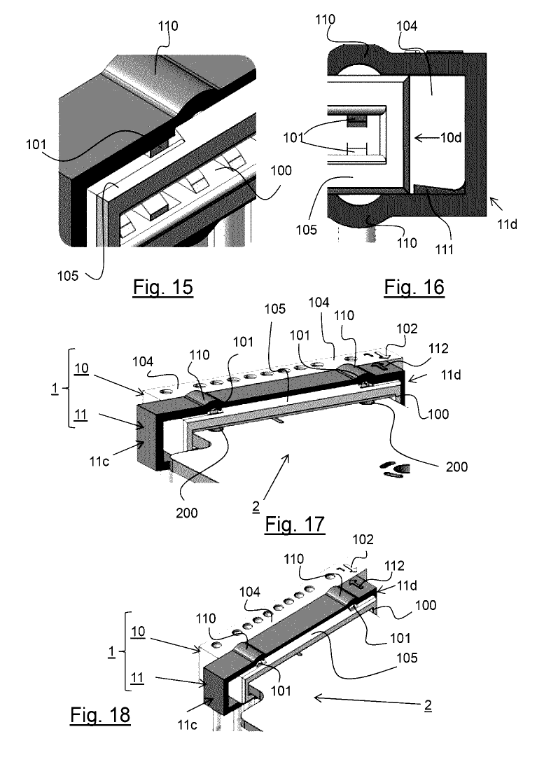

FIG. 15, which is a zoom view, illustrates the cooperation between the holding device 101 and the planar surface of the upper face 11a of the holding element 11. There is a plane to plane contact. The holding device 101 can no longer be moved along the axis Az by virtue of this plane to plane contact.

By virtue of the plane to plane contact, the holding element 11 thus locks the holding device 101 in its lowered position, and the holding device 101 prevents the holding element 11 from sliding.

As is illustrated in FIG. 14, in the locked position p1, the locking device 111 locks the holding element 11 in its locked position p1. The locking device 111 no longer cooperates with the lower face 10b of the jaw 105. It is in a raised position such that it prevents the holding element 101 from sliding. The holding element 101 is thus locked in its locked position p1.

In fact, if a force is applied to the holding element 11 to make it slide in order to reposition it in a locked position p0, the locking device 111 will butt against the lateral face 10d of the jaw 105, preventing the sliding and thus the unlocking of the holding element 11.

FIG. 16, which is a zoom view, illustrates the locking device 111 in the raised position when it prevents the holding element 11 from sliding and holds it in the locked position p1.

In one nonlimiting embodiment, the locking device 111 is adapted to cooperate with a locking element (not shown) provided on the card edge connector 10. In one nonlimiting example, the locking element is an unhooking element which is recessed in or projecting from the jaw 105. If a force is applied to make the holding element 101 slide, so as to move the holding element 11 into the unlocked position p0, the locking device 111 will butt against the edge of this unhooking element.

As is illustrated in FIG. 13, in the locked position p1 the poka-yoke 112 of the holding element 11 is positioned opposite the poka-yoke 102 of the card edge connector 10. This makes it possible to indicate whether the holding element 11 is indeed locked and thus in a locked position p1.

As described above, the connection module 1 cooperates with the printed circuit card 2 when it is inserted in the card edge connector 10.

Thus, for this cooperation,

the card edge connector 10 comprises at least one holding device 101 adapted to cooperate with a holding element 200 of the printed circuit card 2 when the printed circuit card 2 is inserted in the card edge connector 10 so as to position the printed circuit card 2 in the predetermined position; and

the holding element 11 is designed to:
lock the holding device 101 in its cooperation with the holding element 200 so that the printed circuit card 2 is held permanently in the predetermined position when the holding element 11 is in the locked position p1; and
release the holding device 101 from its cooperation with the holding element 200 so as to allow the removal of the printed circuit card 2 from the predetermined position when the holding element 11 is in the unlocked position p0.

The operations done (by a worker in one nonlimiting example) to insert the printed circuit card 2 in the card edge connector 10 and hold it permanently in the card edge connector 10 shall be described below.

In the nonlimiting example described below:

the card edge connector 10 comprises four holding devices 101 disposed on its jaw 105, two on each upper 10a and lower 10b face of the jaw 105. These are clips;

the holding element 11 comprises four corresponding recesses 110;

the locking device 111 is a clip.

the PCB 2 comprises four holding elements 200 which are orifices, two on each face.

In the following description, the holding element 11 is called a slide, the holding devices 101 are called holding clips, the locking device 111 is called a locking clip, and the holding elements 200 are called holding orifices.

In a first step, the slide 11 is disposed in the unlocked position p0 around the jaw 105 of the card edge connector 10 as is illustrated in FIGS. 9 to 12. It is fitted around the jaw 105 until it butts up against the wall of the first part 104 of the card edge connector 10.

In a second step, illustrated in FIG. 17, the PCB 2 is inserted in the card edge connector 10, and in particular the connection edge 20 of the PCB 2 is inserted in the slot 100 of the jaw 105 of the card edge connector 10. As will be seen below, the holding clips 101 will cooperate with the holding orifices 200 when the printed circuit card 2 is inserted in the card edge connector 10 so as to position the PCB 2 in the predetermined position.

As is illustrated in FIG. 17, the holding clips 101 are initially in a raised position before being inserted into the holding orifices 200 of the PCB 2, the PCB 2 not being fully inserted into the slot 100.

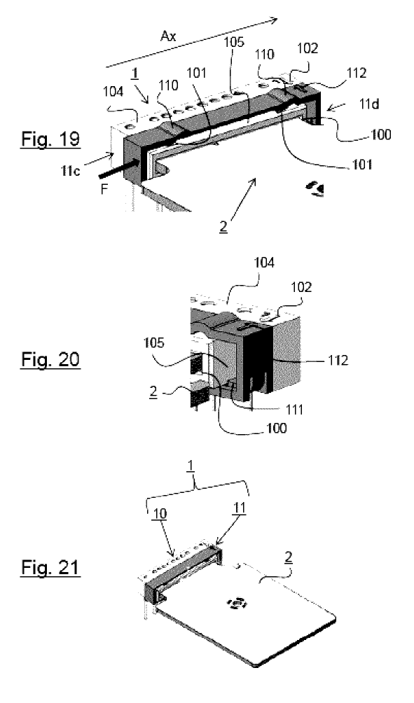

Then, when the connection edge 20 is inserted through to the bottom of the slot 100 of the jaw 105 of the card edge connector 10, the holding clips 101 are introduced into the holding orifices 200. They are then in a lowered position as illustrated in FIG. 18 and the PCB 2 is in its predetermined position.

In this predetermined position:

the electrical contacts of the PCB 2 are in contact with those of the card edge connector 10;

the holding clips 101 are inserted into the holding orifices 200 of the PCB 2. This shows the worker that the PCB 2 is indeed in the predetermined position;

moreover, the holding clips 101 are introduced into the available space created by the recesses 110 of the slide 11;

the poka-yokes 102 and 112 are offset from each other;

the locking clip 111 is in a lowered position and it cooperates with the lower face 11b of the jaw 105 of the card edge connector 10.

In the unlocked position p0, the slide 11 does not lock the holding clips 101 in the holding orifices 200. In fact, if the worker pulls on the PCB 2, the slide 11 releases the holding clips 101 from their cooperation with the holding orifices 200. This enables a removal of the PCB 2 from the predetermined position.

It will be noted that if the PCB 2 has not been properly inserted into the card edge connector 10 (the holding clips 101 are not inserted into the holding orifices 200), the worker will not be able to lock the slide 11. In fact, the holding clips 101 are then still in the raised position and the planar surface of the inner side of the upper face 11a of the slide 11 will then strike against the holding clips 101 if the worker tries to push on the slide 11 in order to lock it.

In a third step, illustrated in FIG. 19, a pressure force F as illustrated is applied to the slide 11 to make it slide along the transverse axis Ax of the card edge connector 10. The pressure force F is applied to the lateral face 11c of the slide 11 in the nonlimiting example illustrated, namely, the one where the locking clip 111 is not located, this latter being located on the other lateral face 11d. The slide 11 slides along the jaw 105 of the card edge connector 10 along the transverse axis Ax.

The slide 11 stops sliding when:

its lateral face 11c is in contact with the lateral face 10c of the jaw 105;

the plane to plane contact is established between the holding clips 101 and the planar surface of the inner side of the upper 10a and lower 10b face of the jaw 105.

At this moment, the slide 11 is in the locked position p1.

In this position:

the holding clips 101 are locked in their cooperation with the holding orifices 200 since they can no longer be raised up. Thus, they cannot exit from the holding orifices 200. The PCB 2 is thus permanently held in the predetermined position in which the connection between contacts is established. It can no longer be removed;

as is illustrated in FIG. 19, the holding clips 101 are no longer in the recesses 110 of the slide 11, but rather in plane to plane contact with the planar surface of the inner side of the upper face 10a and lower face 10b of the jaw 105 of the card edge connector 10, since they have undergone a transverse displacement. The plane to plane contact prevents the slide 11 from sliding transversely;

as is illustrated in FIG. 20, the locking clip 111 is no longer in contact with the lower face 10b of the jaw 105 of the card edge connector 10. Neither is it in the lowered position, but rather in the raised position, so that it prevents the slide 11 from sliding transversely in the direction opposite the pressure force F which has been applied. Thus, it holds the slide 11 in the locked position p1;

as is illustrated in FIGS. 19 and 20, the poka-yokes 112 and 102 are opposite each other, showing the worker that the slide 11 is properly locked in the locked position p1.

Thus, FIG. 21 illustrates the PCB 2 mounted and locked in the predetermined position. It is held permanently so that it cannot be removed from the card edge connector 10. The worker is now assured that the electrical contacts have been properly made and that the card edge connector 10 is not liable to become disconnected from the PCB 2. Thus, the connection between the electrical contacts is secure.

In one nonlimiting embodiment, the connection module 1 as well as the printed circuit card 2 with which it cooperates are integrated in a lighting device. In one nonlimiting example, the lighting device is a headlight. It comprises a housing (not shown) in which the connection module 1 is integrated. In one nonlimiting embodiment, the lighting device comprises a plurality of connection modules 1 and a plurality of printed circuit cards 2. Thus, thanks to the described connection module 1, the worker is assured that the card edge connector 10 will not become disconnected from the PCB especially when installing the connection module 1 in the lighting device and during the operation of the motor vehicle.

Of course, the description of the invention is not limited to the embodiments described above.

Thus, in another nonlimiting embodiment, the holding element 11 is adapted to slide in the direction of insertion of the printed circuit card 2.

Thus, in another nonlimiting embodiment, the operations performed by the worker can be done by a machine (the placement of the slide 11 around the jaw 105, the insertion of the printed circuit card 2 into the jaw 105, the pressure force F exerted on the slide 11).

Thus, in another nonlimiting embodiment, the electronic component whose electrical power supply is driven by the driving circuit is an actuator for the correction of the illumination (for example, modification of the height of the light beam produced by the lighting device, correction during turns, etc.).

Thus, the described invention presents in particular the following advantages:

it prevents a disconnection between the PCB 2 and the card edge connector 10 thanks to the assembly of the card edge connector 10 and the holding element 11;

it guarantees the connection between the electrical contacts of the card edge connector 10 and those of the printed circuit card 2;

it does not modify the design of the printed circuit card 2 with its electronic components;

it is simple to implement;

it is low-cost;

It does not add additional strain for the worker;

it avoids having a housing of the lighting device configured specifically with supplemental mechanical parts (the mating parts) to receive the connection modules. Thus, the design of the housing is simplified and the manufacturing costs are reduced. Thus, there are no longer any integration constraints.

While the system, apparatus, process and method herein described constitute preferred embodiments of this invention, it is to be understood that the invention is not limited to this precise system, apparatus, process and method, and that changes may be made therein without departing from the scope of the invention which is defined in the appended claims.

What is claimed is:

1. A connection module for a motor vehicle adapted to connect a printed circuit card to a power supply network, wherein said connection module comprises:
a card edge connector in which said printed circuit card can be inserted;
a holding element adapted to be in an unlocked position (p0) or in a locked position (p1) and adapted to hold said printed circuit card permanently in said card edge connector when it is in said locked position (p1).

2. The connection module according to claim 1, wherein said holding element is adapted to slide along a transverse axis (Ax) of said card edge connector to move from said unlocked position (p0) to said locked position (p1).

3. The connection module according to claim 1, wherein:
said card edge connector comprises at least one holding device adapted to cooperate with a holding element of said printed circuit card when said printed circuit card is inserted in said card edge connector; and
said holding element is designed to lock said holding device in its cooperation with said holding element and to release said holding device from its cooperation with said holding element.

4. The connection module according to claim 3, wherein said holding element of said printed circuit card is a holding orifice in which said card edge connector can be inserted.

5. The connection module according to claim 3, wherein said holding element is designed to:
enable the movement of said holding device into a raised position when said holding element is in said unlocked position (p0); and
lock said holding device in a lowered position when said holding element is in said locked position (p1).

6. The connection module according to claim 3, wherein said card edge connector comprises at least one holding device disposed on an upper face and/or at least one holding device disposed on a lower face.

7. The connection module according to claim 3, wherein said holding element comprises at least one recess adapted to cooperate with said holding device of said card edge connector when said holding element is in said unlocked position (p0).

8. The connection module according to claim 3, wherein when said connection module is in a lowered position, said holding device is furthermore adapted to prevent said holding element from sliding.

9. The connection module according to claim 1, wherein said holding element comprises furthermore a locking device of said holding element in said locked position (p1).

10. The connection module according to claim 9, wherein said locking device is a snap-in means adapted to be in a raised position when said holding element is in said locked position (p1).

11. The connection module according to claim 1, wherein:
said card edge connector further comprises a first poka-yoke to indicate said locked position of said holding element; and
said holding element further comprises a second poka-yoke adapted to cooperate with said first poka-yoke.

12. The connection module according to claim 1, wherein said card edge connector further comprises a plurality of orifices adapted to receive a power supply harness in order to become connected to said power supply network.

13. The connection module according to claim 1, wherein said card edge connector is composed of:
a first part adapted to receive a power supply harness in order to become connected to said power supply network;
a second part:
comprising a slot in which said printed circuit card can be inserted;
adapted to be inserted in said holding element; and
along which said holding element can slide.

14. A lighting device for a motor vehicle comprising a housing in which is disposed at least one connection module according to claim 1, said at least one connection module being adapted to cooperate with said printed circuit card.

15. The lighting device according to claim 14, wherein said lighting device is a headlight.

16. The connection module according to claim 2, wherein:
said card edge connector comprises at least one holding device adapted to cooperate with a holding element of said printed circuit card when said printed circuit card is inserted in said card edge connector; and
said holding element is designed to lock said holding device in its cooperation with said holding element and to release said holding device from its cooperation with said holding element.

17. The connection module according to claim 4, wherein said holding element is designed to:
enable the movement of said holding device into a raised position when said holding element is in said unlocked position (p0); and
lock said holding device in a lowered position when said holding element is in said locked position (p1).

18. The connection module according to claim 4, wherein said card edge connector comprises at least one holding device disposed on an upper face and/or at least one holding device disposed on a lower face.

19. The connection module according to claim 4, wherein said holding element comprises at least one recess adapted to cooperate with said holding device of said card edge connector when said holding element is in said unlocked position (p0).

20. The connection module according to claim 4, wherein when said connection module is in a lowered position, said holding device is furthermore adapted to prevent said holding element from sliding.
